(19) United States
(12) Patent Application Publication
(10) Pub. No.: US 2021/0344142 A1
(43) Pub. Date: Nov. 4, 2021

(54) PLUG CONNECTOR AND CONNECTOR ASSEMBLY HAVING THE SAME

(71) Applicant: LOTES CO., LTD, Keelung (TW)

(72) Inventors: Wen Chang Chang, Keelung (TW); Qi Xiao Yang, Keelung (TW); Chih Kun Chen, Keelung (TW)

(21) Appl. No.: 17/034,465

(22) Filed: Sep. 28, 2020

(30) Foreign Application Priority Data
Apr. 29, 2020 (CN) 202010357413.0

(51) Int. Cl. H01R 13/627; H01R 24/60; H01R 13/639

(52) U.S. Cl. CPC H01R 13/6273; H01R 13/639; H01R 24/60

(57) ABSTRACT

A plug connector is used to be inserted into a socket connector. The plug connector includes: an insulating body, including a main body portion and a locking arm extending from the main body portion; and at least one mating terminal provided in the insulating body. Two locking portions are formed by laterally protruding from left and right sides of the locking arm. Each locking portion is used to be locked with a clip portion of the socket connector, and is located in front of a connecting location of the locking arm and the main body portion. A pressing portion is formed between the two locking portions by protruding upward from the locking arm, and aligning with the locking portions in a left-right direction. The at least one mating terminal is provided with at least one mating portion to mate with at least one conductive terminal of the socket connector.

### CROSS-REFERENCE TO RELATED PATENT APPLICATION

This non-provisional application claims priority to and the benefit of, pursuant to 35 U.S.C. § 119(a), patent application Serial No. CN202010357413.0 filed in China on Apr. 29, 2020. The disclosure of the above application is incorporated herein in its entirety by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference were individually incorporated by reference.

### FIELD

The present invention relates to a plug connector and a connector assembly having the same, and particularly to a connector assembly in which a socket connector is locked by a locking arm of a plug connector.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

An existing plug connector and a socket connector to be mated thereto form a connector assembly. The socket connector includes an insulating seat and a plurality of conductive terminals provided in the insulating seat. The insulating seat is provided with a mating space concavely provided backward on its front end surface, a top wall located above the mating space, and two clamping slots running upward through the top wall and provided at an interval in the left-right direction. The plug connector includes an insulating body and a plurality of mating terminals provided in the insulating body. The insulating body is provided with a main body portion and an elastic arm connected to the main body portion. The elastic arm is provided with a first arm extending upward and then horizontally forward from the top surface of the main body portion, and a second arm formed by extending upward and forward from the front end of the first arm. A distance between the second arm and the top surface of the main body portion is greater than a distance between the first arm and the top surface of the main body portion. Two buckling portions are formed by protruding upward from the top surface of the first arm and separated in the left-right direction. A pressing portion is provided at the front end of the second arm. In the front-rear direction, a distance between each of the two buckling portions and a connecting location of the first arm to the main body portion is less than a distance between each of the two buckling portions and the pressing portion. The plug connector is inserted backward into the mating space. The mating terminals are conductively connected to the conductive terminals, and the two buckling portions are buckled to the corresponding clamping slots. The pressing portion is pressed downward, and the buckling portions move downward, thereby facilitating retreat of the buckling portions to detach from the corresponding clamping slots.

A distance between each of the two buckling portions and a connecting location of the first arm and the main body portion is less than a distance between each of the two buckling portions and the pressing portion. When the pressing portion is pressed downward, and the pressing portion moves downward in a greater distance, the two buckling portions move downward in a smaller distance. Thus, to facilitate the detachment of the buckling portions from the clamping slots, the pressing portion needs to move downward for a sufficiently long distance. However, this will cause the elastic arm to fatigue and even break due to being pressed excessively, and resulting in failure of the locking function. Further, such structure needs to provide the second arm with a sufficiently high distance from the top surface of the main body portion to allow it to deform. However, this will cause the plug connector to be designed with a higher height, which is not conducive to a thin design.

Therefore, a heretofore unaddressed need to design a novel plug connector and a connector assembly having the same exists in the art to address the aforementioned deficiencies and inadequacies.

### SUMMARY

In view of the deficiency of the background, the present invention is directed to a plug connector and a connector assembly having the same, in which a pressing portion of a locking arm of the plug connector, with a small downward movement, may facilitate detachment of the plug connector and a socket connector.

To achieve the foregoing objective, the present invention adopts the following technical solutions.

A plug connector is configured to be inserted into a socket connector. The plug connector includes: an insulating body, comprising a main body portion and a locking arm formed by extending from a top surface of the main body portion, wherein two locking portions are formed by laterally protruding from a left side and a right side of a front end of the locking arm, each of the locking portions is configured to be locked with a clip portion of the socket connector, each of the locking portions is located in front of a connecting location of the locking arm and the main body portion, a pressing portion is formed between the two locking portions by protruding upward from the front end of the locking arm, and the pressing portion is provided to align with the locking portions in a left-right direction; and at least one mating terminal, provided in the insulating body, wherein the at least one mating terminal is provided with at least one mating portion to mate with at least one conductive terminal of the socket connector.

In certain embodiments, the locking arm comprises a first elastic arm formed by extending upward and backward from a top surface of the main body portion and a second elastic arm formed by extending forward from the first elastic arm, the second elastic arm is located above the first elastic arm, a separation slot is formed between the first elastic arm and the second elastic arm, the locking portions are formed by laterally protruding from a front end of the second elastic arm in the left-right direction, and the locking portions are located in front of the first arm.

In certain embodiments, the second elastic arm comprises a first portion connected to the first elastic arm and a second portion extending forward from the first portion, a portion of the second elastic arm passing forward beyond the first elastic arm is defined as the second portion, and in a vertical direction, a distance between the second portion and the top surface of the main body portion is greater than a distance between the first portion and the first elastic arm.

In certain embodiments, the pressing portion and the two locking portions are provided on the second portion.

In certain embodiments, a back end of each of the locking portions is located in front of the first elastic arm.

In certain embodiments, a connecting location of the first elastic arm and the second elastic arm passes backward beyond a back end surface of the main body portion.

In certain embodiments, a top surface of each of the locking portions is not higher than a top surface of the locking arm.

In certain embodiments, each of the locking portions is provided with an guiding chamfer facing upward, the guiding chamfer is provided obliquely forward and upward from a back end surface of each of the locking portions, and a back end of the guiding chamfer is located in front of a back end of the pressing portion.

In certain embodiments, the main body portion is provided with at least accommodating hole accommodating the at least one mating terminal and at least one through hole running through the top surface of the main body portion, the at least one accommodating hole runs through the main body portion in a front-rear direction, each of the at least one through hole is in communication with a corresponding one of the at least one accommodating hole, each of the at least one mating terminal is provided with a blocking portion, the blocking portion protrudes into the through hole to prevent the mating terminal from retreating from the accommodating hole, and a front end surface of the second arm is located behind the through hole.

A connector assembly includes: a socket connector, comprising an insulating seat and at least one conductive terminal provided in the insulating seat, wherein the insulating seat comprises a rear wall and a top wall formed by protruding forward from the rear wall, the rear wall and the top wall form a mating space, a recess is backward concavely provided on a front end of the top wall, the insulating seat is provided with two clip portions at a left side and a right side of the recess, and the conductive terminal has a contact portion exposed to the mating space; and a plug connector, inserted backward into the mating space of the socket connector, wherein the plug connector comprises an insulating body and at least one mating terminal provided in the insulating body, the insulating body is provided with a main body portion and a locking arm formed by extending from a top surface of the main body portion, the locking arm is accommodated in the recess, two locking portions are formed by respectively protruding from a left side and a right side of a front end of the locking arm, the two locking portions are located in front of a connecting location of the locking arm and the main body portion, the two locking portions are respectively located behind the two clip portions correspondingly such that the locking portions and the clip portions are correspondingly locked to each other, a pressing portion is formed by protruding upward from the front end of the locking arm, the pressing portion is located between the two locking portions and aligned to the two locking portions in a left-right direction, and the mating terminal is provided with a mating portion to be conductively connected to the contact portion.

In certain embodiments, a top surface of the pressing portion is higher than a top surface of each of the clip portions.

In certain embodiments, a top surface of each of the locking portions is lower than a top surface of each of the clip portions.

In certain embodiments, the locking arm comprises a first elastic arm formed by extending upward and backward from a top surface of the main body portion and a second elastic arm formed by extending forward from the first elastic arm, the second elastic arm is located above the first elastic arm, a separation slot is formed between the first elastic arm and the second elastic arm, the locking portions are formed by protruding from a front end of the second elastic arm in the left-right direction, and the locking portions are located in front of the first arm.

In certain embodiments, in a vertical direction, a distance between a portion of the second elastic arm passing forward beyond the first elastic arm and the top surface of the main body portion is greater than a distance between a top surface of each of the locking portions and a bottom surface of a corresponding one of the clip portions.

In certain embodiments, the main body portion is provided with at least accommodating hole accommodating the at least one mating terminal and at least one through hole running through the top surface of the main body portion, the at least one accommodating hole runs through the main body portion in a front-rear direction, each of the at least one through hole is in communication with a corresponding one of the at least one accommodating hole, each of the at least one mating terminal is provided with a blocking portion, the blocking portion protrudes into the through hole to prevent the mating terminal from retreating from the accommodating hole, and a front end surface of the second arm is located behind the through hole.

In certain embodiments, two protruding portions are formed by respectively extending upward from the top wall at a left side and a right side of the recess, and each of the clip portions is formed by protruding from a corresponding one of the two protruding portions toward the recess in the left-right direction.

In certain embodiments, each of the clip portions is provided with a first guiding chamfer facing downward, the first guiding chamfer is provided obliquely backward and downward from a front end surface of each of the clip portions, each of the locking portions is provided with a second guiding chamfer facing upward, the second guiding chamfer is provided obliquely forward and upward from a back end surface of each of the locking portions, the second guiding chamfer is guided by the first guiding chamfer, such that each of the locking portions moves to be behind a corresponding one of the clip portions.

In certain embodiments, a bottom surface of each of the clip portions and a top surface of the top wall are located on a same horizontal plane in a vertical direction.

In certain embodiments, each of the two side walls comprises an extending arm and an elastic arm provided close to the mating space relative to the extending arm, the elastic arm has a first arm extending forward from the extending arm and a second arm bending reversely from the first arm and extending backward, the second arm is backward connected to the rear wall, an opening slot is formed between the first arm and the extending arm and runs forward therethrough, a through slot is formed between the second arm and the first arm, a buckling portion is formed at a side of the second arm away from the first arm, the buckling portion is provided to correspond to the through slot and the opening slot in a left-right direction, and two clamping portions are respectively provided at a left side and a right side of the main body portion to correspondingly buckle with the buckling portions and to lock the plug connector to and the socket connector.

In certain embodiments, the opening slot comprises a first slot and a second slot connected to a back end of the first slot, the first slot runs forward through a corresponding side wall of the two side walls, and a width of a front end of the first slot in a left-right direction is greater than a width of the back end of the first slot in the left-right direction.

In certain embodiments, the extending arm of each of the two side walls is fixed with a fixing member, the fixing member is provided with a retaining portion and a mounting portion, the retaining portion is fixed with interference to a corresponding side wall of the two side walls at a location behind the opening slot, and the mounting portion is configured to be mounted on a circuit board.

In certain embodiments, two grooves are backward concavely provided on a left side and a right side of a front end of the top wall respectively, each of the two grooves is provided to be adjacent to the second arm of a corresponding side wall of the two side walls, the clamping portions are located behind the buckling portion, and each of the clamping portions is exposed to a corresponding groove of the two grooves.

Compared with the related art, the plug connector and the connector assembly having the same according to certain embodiments of the present invention have the following beneficial effects.

The locking portions are located at the front end of the locking arm. That is, the locking portions are substantially located at the free tail end of the locking arm. The pressing portion is provided to align with the locking portions in the left-right direction. By pressing the pressing portion downward, the locking portions also move downward together in a greater distance, such that the locking arm, with a small deformation amount, may facilitate detachment of the locking portions and the corresponding clip portions, thereby suppressing the locking arm from fatigue and even breaking due to being excessively pressed, and ensuring the usage life of the locking arm. In addition, the locking portions are laterally formed from the left side and the right side of the locking arm respectively, such that the plug connector may facilitate a thin design.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment, and wherein:

FIG. 1 is a perspective exploded view of a plug connector and a connector assembly having the same according to one embodiment of the present invention.

FIG. 2 is a perspective assembled view of FIG. 1.

FIG. 3 is a perspective view of the socket connector in FIG. 2 from another viewing angle.

FIG. 4 is a top view of FIG. 2.

FIG. 5 is an enlarged view of a part B in FIG. 4.

FIG. 6 is a schematic view of the plug connector and the socket connector in FIG. 5 prior to completion of mating.

FIG. 7 is a perspective view of FIG. 2 sectioned along a line A-A.

FIG. 8 is a side view of the plug connector in FIG. 2.

FIG. 9 is a front view of FIG. 2.

FIG. 10 is a sectional view of the connector assembly and the circuit board in FIG. 9 sectioned along a line C-C.

FIG. 11 is a schematic view of the plug connector in FIG. 10 in a process of being inserted into the socket connector but the two are not clamped together.

FIG. 12 is a schematic view of the plug connector further inserting into the socket connector in FIG. 11 but the two are not clamped together.

### DETAILED DESCRIPTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprising”, “including”, “carrying”, “having”, “containing”, “involving”, and the like are to be understood to be open-ended, i.e., to mean including but not limited to.

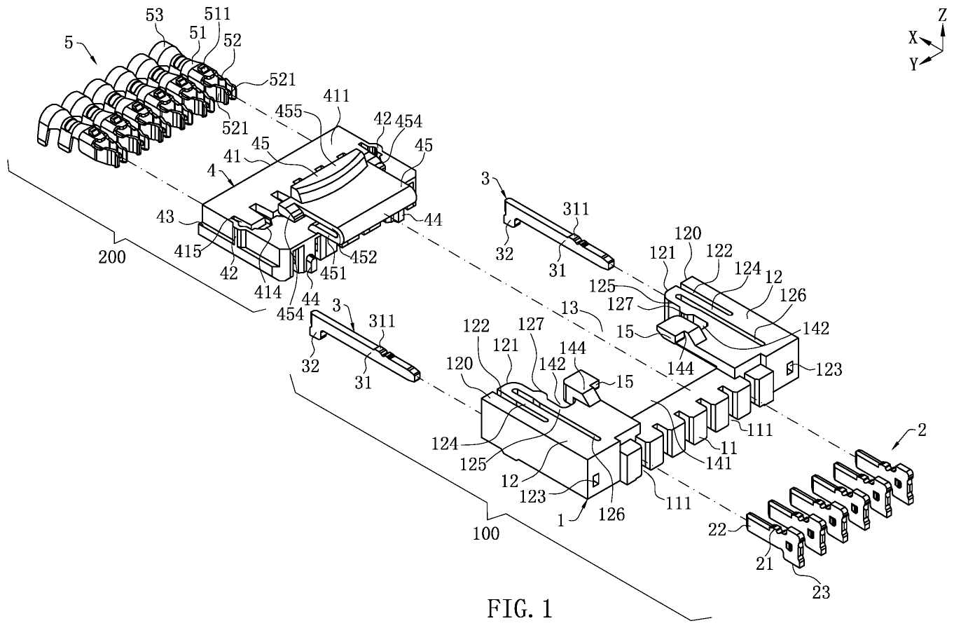

The description will be made as to the embodiments of the present invention in conjunction with the accompanying drawings in FIGS. 1-12. In accordance with the purposes of this invention, as embodied and broadly described herein, this invention, in one aspect, relates to a plug connector and a connector assembly having the same.

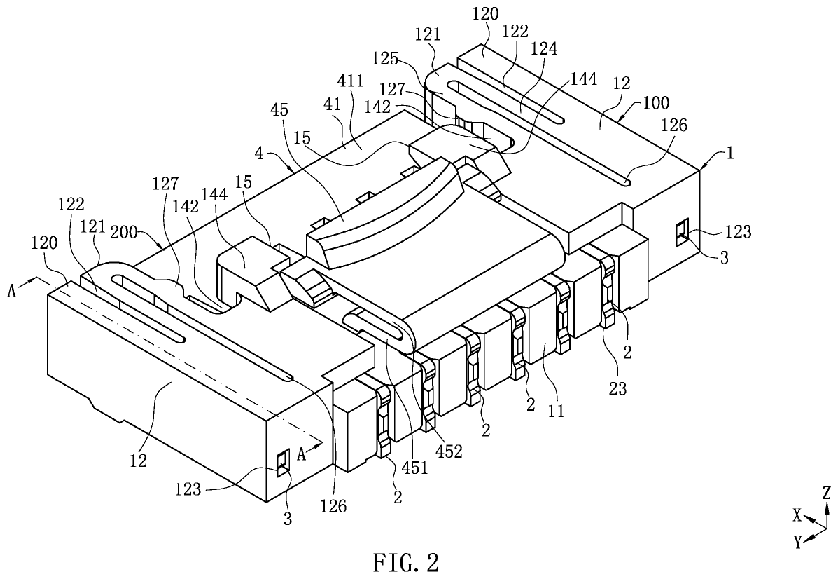

As shown in FIG. 1 and FIG. 2, in a plug connector 200 and a connector assembly having the same according to certain embodiments of the present invention, a forward direction in a front-rear direction is defined as the positive direction of the X-axis, a leftward direction in a left-right direction is defined as the positive direction of the Y-axis, and an upward direction in a vertical direction is defined as the positive direction of the Z-axis.

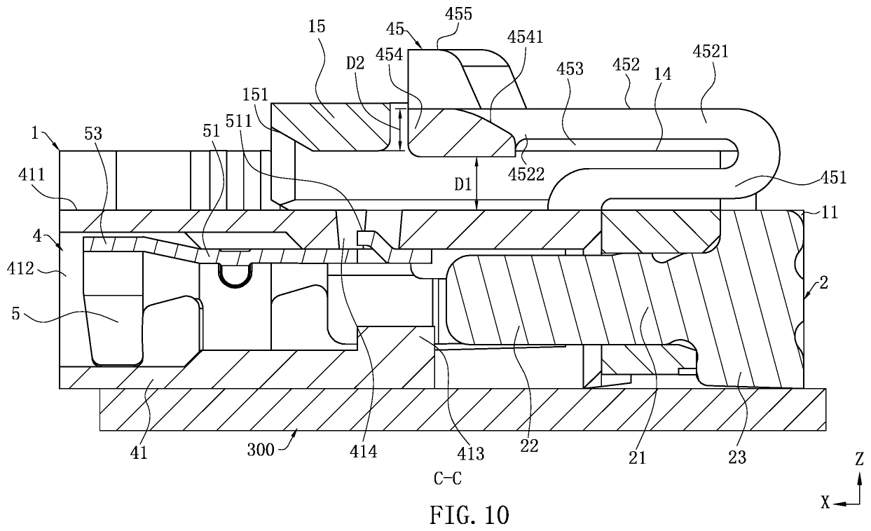

FIG. 1, FIG. 2 and FIG. 10 show a plug connector 200 and a connector assembly having the plug connector 200 according to one embodiment of the present invention. The connector assembly includes a socket connector 100 and a plug connector 200. The socket connector 100 is downward mounted onto a circuit board 300. The plug connector 200 is used to be electrically connected to a cable (not shown).

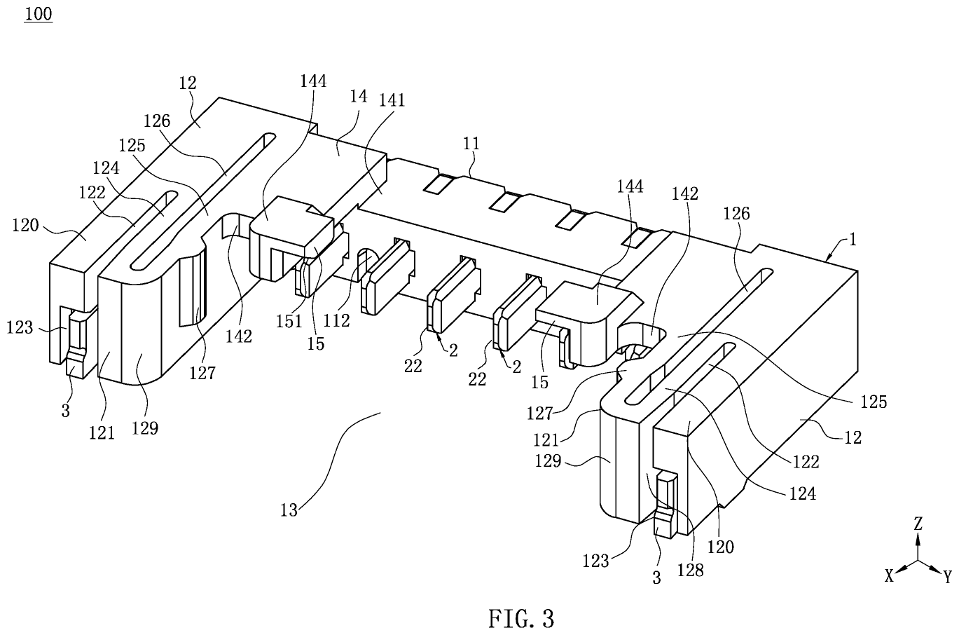

As shown in FIG. 1 and FIG. 3, the socket connector 100 includes an insulating seat 1, a plurality of conductive terminals 2 accommodated in the insulating seat 1, and two fixing members 3. In other embodiments, it is possible to provide only one conductive terminal 2.

As shown in FIG. 1 and FIG. 3, the insulating seat 1 includes a rear wall 11 and two side walls 12 located at a left side and a right side of the rear wall 11. The two side walls 12 are connected to the rear wall 11, and the rear wall 11 and the two side walls 12 surroundingly form a mating space 13. The insulating seat 1 further includes a top wall 14 connected to the rear wall 11. The top wall 14 is connected to the two side walls 12 in the left-right direction, and the top wall 14 is located above the mating space 13.

As shown in FIG. 1 and FIG. 3, the rear wall 11 is provided with a plurality of terminal holes 111 and a plurality of positioning slots 112. The terminal holes 111 run through the rear wall 11 in the front-rear direction. Each positioning slot 112 is formed by being backward concavely provided on a front end surface of the rear wall 11. Each positioning slot 112 runs downward through a bottom surface of the rear wall 11 but does not run backward through a back end surface of the rear wall 11. Two positioning slots 112 are provided. The positioning slots 112 and the terminal holes 111 are provided to be staggered in the left-right direction. The two positioning slots 112 are substantially located at a left side and a right side of the rear wall 11.

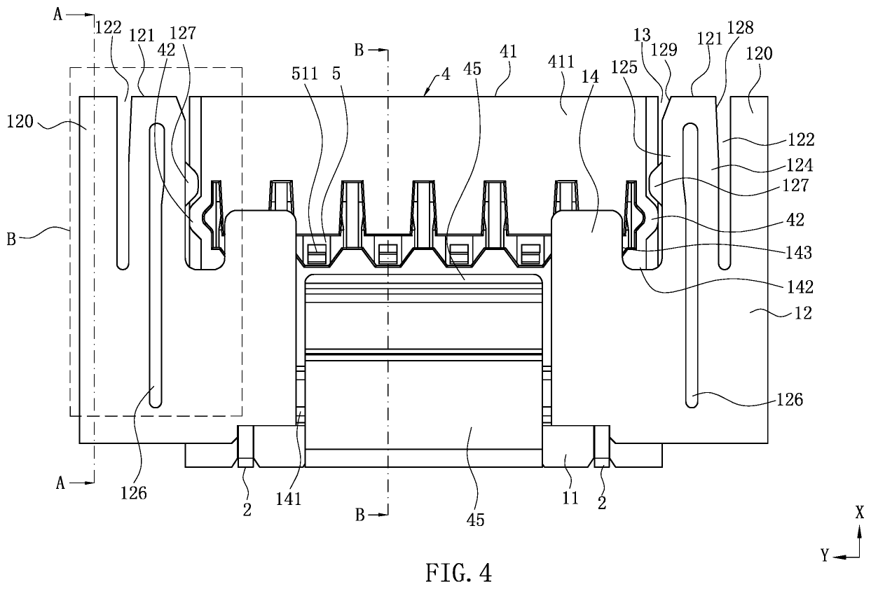

As shown in FIG. 3 and FIG. 4, each side wall 12 is provided with an extending arm 120 and an elastic arm 121 provided close to the mating space 13 relative to the extending arm 120. An opening slot 122 is formed between the elastic arm 121 and the extending arm 120. The opening slot 122 extends along the front-rear direction and runs forward through the corresponding side wall 12, and the opening slot 122 simultaneously runs vertically through the corresponding side wall 12.

As shown in FIG. 2 and FIG. 3, each extending arm 120 is provided with a fixing slot 123. The fixing slot 123 is in communication with the opening slot 122 in the left-right direction. The fixing slot 123 runs through the corresponding side wall 12 in the front-rear direction.

As shown in FIG. 3 and FIG. 4, the elastic arm 121 has a first arm 124 formed by extending forward from the extending arm 120 and a second arm 125 formed by bending reversely from the first arm 124 and extending backward. The second arm 125 is backward connected to the rear wall 11. The second arm 125 is provided to be close to the mating space 13 relative to the first arm 124 in the left-right direction.

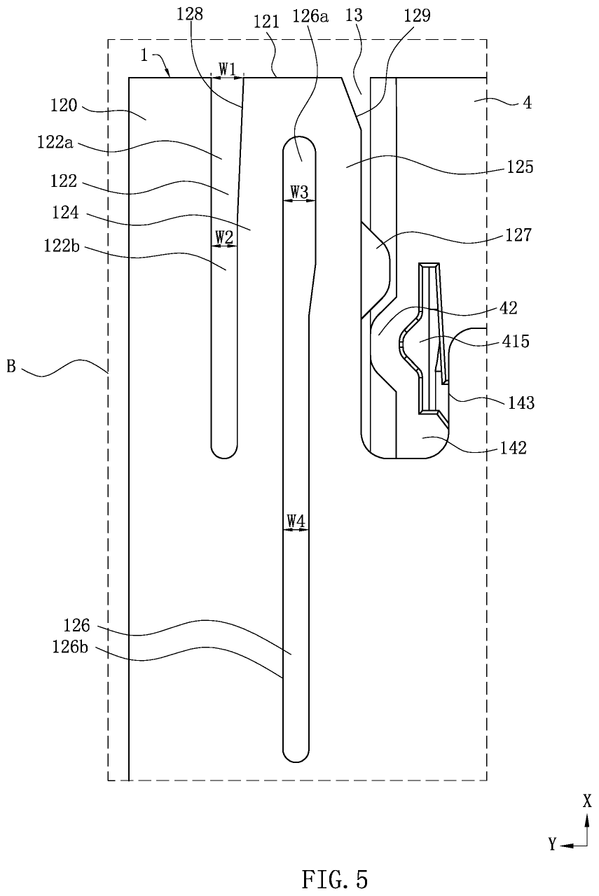

As shown in FIG. 3, FIG. 4 and FIG. 5, the opening slot 122 is formed between the first arm 124 and the extending arm 120. The opening slot 122 includes a first slot 122a and a second slot 122b connected to a back end of the first slot 122a. The first slot 122a runs forward through the corresponding side wall 12. A width W1 of a front end of the first slot 122a in the left-right direction is greater than a width W2 of the back end of the first slot 122a in the left-right direction. A back end of the second slot 122b is located in front of the rear wall 11. The first arm 124 is provided with an oblique surface 128 connected to a front end surface of the first arm 124 and facing the opening slot 122. The oblique surface 128 is provided to correspond to the first slot 122a.

As shown in FIG. 3, FIG. 4 and FIG. 5, the second arm 125 and the first arm 124 are provided in parallel, and a through slot 126 is formed therebetween. The through slot 126 extends backward to pass beyond the opening slot 122 but does not run backward through the rear wall 11. The through slot 126 runs vertically through the corresponding side wall 12. The through slot 126 includes a front through slot 126a and a rear through slot 126b. A width W3 of the front through slot 126a in the left-right direction is greater than a width W4 of the rear through slot 126b in the left-right direction. A buckling portion 127 is formed at a side of the second arm 125 away from the first arm 124. The buckling portion 127 is formed by protruding from the second arm 125 toward the mating space 13. A distance between the buckling portion 127 and the front end surface of the corresponding side wall 12 is less than a distance between the buckling portion 127 and the front end surface of the rear wall 11. The buckling portion 127 is located in front of the front end of the top wall 14, and the buckling portion 127 is provided to correspond to the front through slot 126a and the opening slot 122 in the left-right direction. The second arm 125 is further provided with a guiding chamfer 129 connected to the front end surface of the second arm 125 and facing the mating space 13. A back end of the oblique surface 128 passes backward beyond the guiding chamfer 129.

As shown in FIG. 3, FIG. 4 and FIG. 5 a recess 141 and two grooves 142 are backward concavely provided on the front end of the top wall 14. The recess 141 is located between the two grooves 142 in the left-right direction, and the three are provided separately. The recess 141 and the mating space 13 are provided to be in communication in the vertical direction. A width of each groove 142 in the left-right direction is less than that of the recess 141. The recess 141 extends backward to the rear wall 11, and each groove 142 does not extend backward to the rear wall 11. That is, a back end of each groove 142 is located in front of the recess 141. Thus, the recess 141 divides the top wall 14 into two portions. The back end of each groove 142 and the back end of the second slot 122b are flush in the front-rear direction. Each groove 142 and a corresponding second arm 125 are provided to be adjacent. The back end of each groove 142 is located behind a corresponding buckling portion 127. Each groove 142 is provided with a side edge 143 in the left-right direction, and the corresponding buckling portion 127 does not pass beyond the side edge 143 of the corresponding groove 142 in the left-right direction.

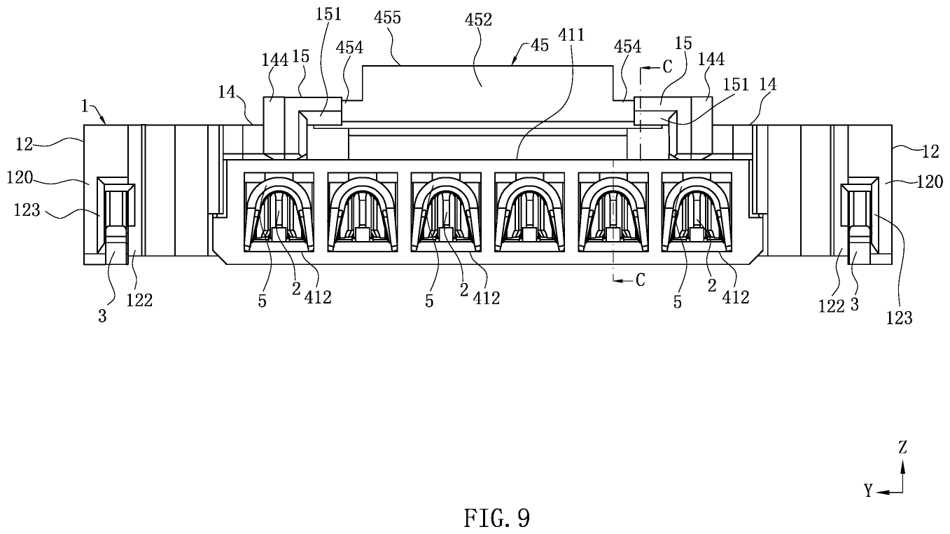

As shown in FIG. 3, FIG. 9 and FIG. 10, the insulating seat 1 is provided with two protruding portions 144 located at the left side and the right side of the recess 141. Each protruding portion 144 is formed by protruding upward from the top surface of the top wall 14. Each protruding portion 144 is provided to be adjacent to the corresponding groove 142, and is located closer to the recess 141 relative to the corresponding groove 142. A clip portion 15 is formed by protruding from each protruding portion 144 toward the recess 141 in the left-right direction. A bottom surface of the clip portion 15 is flush with the top surface of the top wall 14, and a top surface of the clip portion 15 is higher than the top wall 14. Each clip portion 15 is provided with a guiding chamfer facing downward, which is defined as a first guiding chamfer 151. The first guiding chamfer 151 is provided obliquely backward and downward from a front end surface of the corresponding clip portion 15.

As shown in FIG. 1, FIG. 3 and FIG. 10, each conductive terminal 2 is formed by blanking from a metal plate. The conductive terminals 2 are one-to-one correspondingly accommodated in the terminal holes 111. Each conductive terminal 2 is provided with a fixing portion 21, a contact portion 22 extending forward from the fixing portion 21 and a soldering portion 23 extending backward from the fixing portion 21. The fixing portion 21 is fixed to a corresponding terminal hole 111 in the vertical direction. The contact portion 22 protrudes forward into the mating space 13. The soldering portion 23 protrudes downward out of a bottom surface of the insulating seat 1 to be soldered to the circuit board 300.

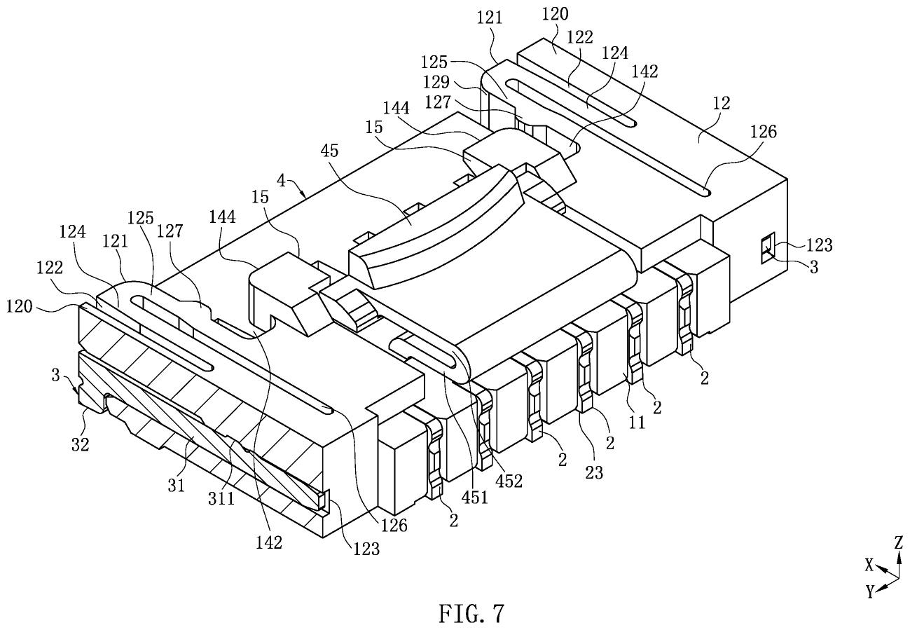

As shown in FIG. 2, FIG. 3, FIG. 5 and FIG. 7, the two fixing members 3 are fixed to the fixing slots 123 of the two side walls 12. That is, each fixing member 3 is correspondingly fixed to one of the fixing slots 123. The fixing members 3 protrude backward to pass beyond the front end surface of the rear wall 11. A side of each fixing member 3 facing the mating space 13 in the left-right direction is exposed to the corresponding opening slot 122. Each fixing member 3 is provided with a retaining portion 31 extending in the front-rear direction and a mounting portion 32 exposed downward to a bottom surface of the corresponding extending arm 120. The retaining portion 31 is located behind the mounting portion 32. The retaining portion 31 is provided with a plurality of barbs 311, and the barbs 311 interfere with the corresponding side wall 12 behind the second slot 122b. The mounting portion 32 is located in front of the corresponding buckling portion 127, and the mounting portion 32 is soldered downward to the circuit board 300 (also referring to FIG. 10) to fix the socket connector 100.

As shown in FIG. 1 and FIG. 10, the plugconnector 200 includes an insulating body 4 and a plurality of mating terminals 5 accommodated in the insulating body 4. In other embodiments, it is possible to provide only one mating terminal 5.

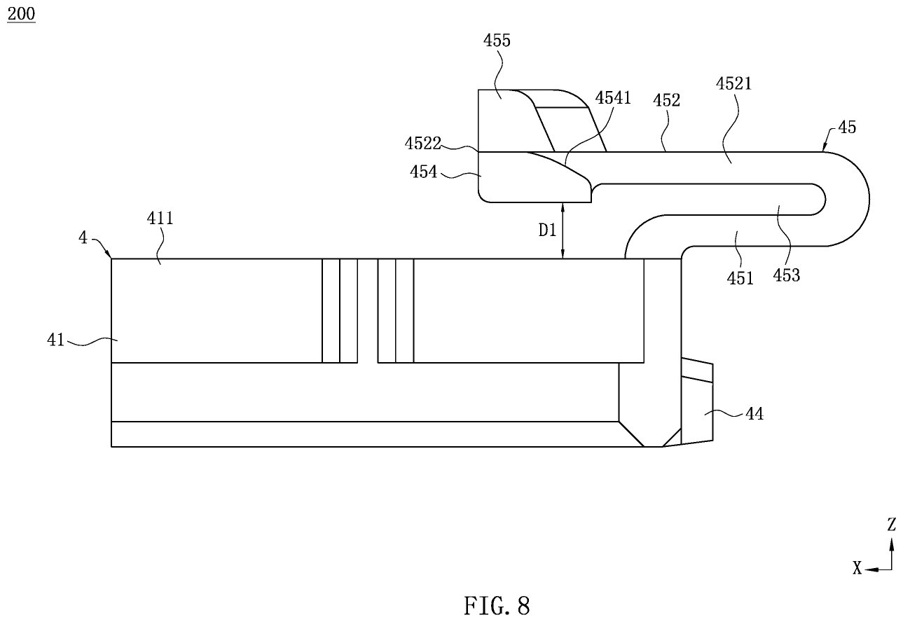

As shown in FIG. 1, FIG. 4 and FIG. 8, the insulating body 4 includes a main body portion 41, two clamping portions 42 and two guiding portions 43 respectively located at a left side and a right side of the main body portion 41, a plurality of positioning protruding portion 44 protruding backward from the main body portion 41, and a locking arm 45 extending upward from the main body portion 41.

As shown in FIG. 1, FIG. 4 and FIG. 10, the main body portion 41 is inserted backward into the mating space 13. The main body portion 41 is provided with a top surface 411 in the vertical direction and a plurality of accommodating holes 412. Each accommodating hole 412 runs through the main body portion 41 in the front-rear direction. The main body portion 41 is provided with a protruding block 413 protruding upward and corresponding to each accommodating hole 412. The protruding block 413 is located in front of the contact portion 22 of a corresponding conductive terminal 2 to limit the corresponding conductive terminal 2 from being excessively inserted forward into the corresponding accommodating hole 412. The main body portion 41 is provided with a plurality of through holes 414 running through the top surface 411 but not running through the bottom surface of the main body portion 41, and two reserved slots 415. The through holes 414 one-to-one correspond and are in communication with the accommodating holes 412. The two reserved slots 415 are provided at a left side and a right side of the accommodating holes 412, and each reserved slot 415 and the adjacent through hole 414 are provided to be staggered in the front-rear direction and in communication with each other. In this embodiment, the through holes 414 are in communication with each other along the left-right direction.

As shown in FIG. 1, FIG. 4 and FIG. 5, the clamping portions 42 and the guiding portions 43 are formed by laterally protruding from the main body portion 41 in the left-right direction. At a same side of the main body portion 41, the guiding portion 43 is located below the corresponding clamping portion 42 and is connected to the corresponding clamping portion 42 in the vertical direction, and the guiding portion 43 extends forward to the front end surface of the main body portion 41 and extends backward to the back end surface of the main body portion 41. A certain distance exists between the clamping portion 42 and each of the front end surface and the back end surface of the main body portion 41, and a distance between the clamping portion 42 and the front end surface of the main body portion 41 is less than a distance between the clamping portion 42 and the back end surface of the main body portion 41. The clamping portions 42 and the corresponding buckling portions 127 are buckled to each other to lock the socket connector 100 and the plug connector 200. Each clamping portion 42 is located behind the corresponding buckling portion 127, and is exposed upward to the corresponding groove 142. Each guiding portion 43 is located below the corresponding clamping portion 42 to suppress the plug connector 200 from excessively moving upward. Each clamping portion 42 is provided to correspond to one of the reserved slots 415 in the left-right direction 415, and the reserved slots 415 provide deformation spaces for the corresponding clamping portions 42.

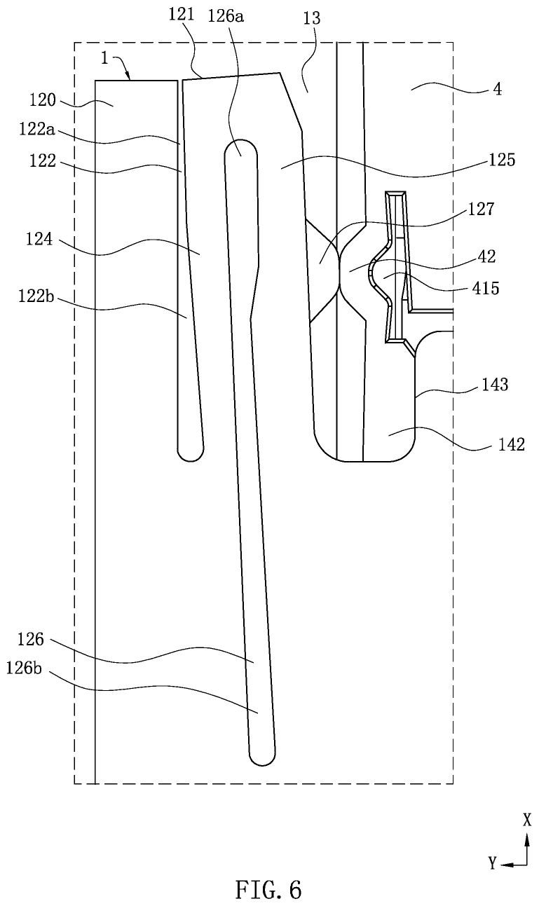

As shown in FIG. 4, FIG. 5 and FIG. 6, in the process for each clamping portion 42 and the corresponding buckling portion 127 to be buckled to each other, the elastic arm 121 deviates toward the extending arm 120. The opening slot 122 provides the deformation space for the first arm 124, and the through slot 126 provides the deformation space for the second arm 125, such that the elastic arm 121 has a longer arm, elasticity becomes better, and the usage life is increased. Each clamping portion 42 deforms toward the corresponding reserved slot 415.

As shown in FIG. 1, the positioning protruding portions 44 are formed by protruding backward from the back end surface of the main body portion 41. In this embodiment, the quantity of the positioning protruding portions 44 corresponds to the quantity of the positioning slots 112, which is two. Each positioning protruding portion 44 is inserted backward into a corresponding positioning slot 112 to position the plug connector 200 at a location relative to the socket connector 100 (also referring to FIG. 3).

As shown in FIG. 1, FIG. 8 and FIG. 10, the locking arm 45 protrudes backward into the recess 141, and is located above the rear wall 11. The locking arm 45 is provided with a first elastic arm 451 formed by extending upward and backward from the top surface 411 of the main body portion 41, and a second elastic arm 452 formed by extending forward from the first elastic arm 451. The second elastic arm 452 is located above the first elastic arm 451, and a separation slot 453 is formed between the first elastic arm 451 and the second elastic arm 452. A pressing portion 455 is formed by protruding upward from the top surface of the second elastic arm 452, and two locking portions 454 are respectively formed by laterally protruding from a left side and a right side of the second elastic arm 452. The first elastic arm 451 and the second elastic arm 452 are provided in parallel in the vertical direction.

As shown in FIG. 8, the first elastic arm 451 is formed by extending upward and then horizontally backward from the top surface 411 of the main body portion 41. A back end of the first elastic arm 451 passes backward beyond the back end surface of the main body portion 41. A portion of the first elastic arm 451 horizontally extending is in parallel to the top surface 411 of the main body portion 41 in the vertical direction.

As shown in FIG. 8 and FIG. 10, the second elastic arm 452 includes a first portion 4521 connected to the back end of the first elastic arm 451 and a second portion 4522 formed by extending forward from the first portion 4521. A portion of the second elastic arm 452 passing forward beyond the first elastic arm 451 is defined as the second portion 4522. A front end surface of the second portion 4522 is located behind the corresponding through hole 414. A top surface of the first portion 4521 and a top surface of the second portion 4522 are flush. The pressing portion 455 is formed by protruding upward from the top surface of the front end of the second portion 4522. In the vertical direction, a distance between the second portion 4522 and the top surface 411 of the main body portion 41 is defined as a first distance D1, and the first distance D1 is greater than a distance between the first portion 4521 and the first elastic arm 451.

As shown in FIG. 3, FIG. 8 and FIG. 10, the locking portions 454 are respectively formed by laterally protruding from the left side and the right side of the second portion 4522. The pressing portion 455 is located between the two locking portions 454, and is aligned with the two locking portions 454 in the left-right direction. A back end surface of each locking portion 454 is located in front of the corresponding first elastic arm 451. A bottom surface of each clip portion 15 and the top surface of the top wall 14 are located on a same horizontal plane in the vertical direction. The top surface of each locking portion 454 is not higher than the top surface of the second portion 4522. In this embodiment, the top surface of each locking portion 454 is flush with the top surface of the second portion 4522. The pressing portion 455, the two locking portions 454 and the front end surface of the second elastic arm 452 are flush, and are all located behind the corresponding through hole 414.

As shown in FIG. 8 and FIG. 10, the top surface of each locking portion 454 is lower than the top surface of the corresponding clip portion 15. A distance between the top surface of each locking portion 454 and the bottom surface of the corresponding clip portion 15 is defined as a second distance D2, and the second distance D2 is less than the first distance D1. The top surface of the pressing portion 455 is higher than the top surface of the corresponding clip portion 15.

As shown in FIG. 3 and FIG. 10, each locking portion 454 is provided with a guiding chamfer facing upward, which is defined as a second guiding chamfer 4541. The second guiding chamfer 4541 is provided obliquely forward and upward from the back end surface of the corresponding locking portion 454. A back end of the second guiding chamfer 4541 is located in front of the pressing portion 455. The second guiding chamfer 4541 is guided by the first guiding chamfer 151, such that the corresponding locking portion 454 moves to be behind the corresponding clip portion 15.

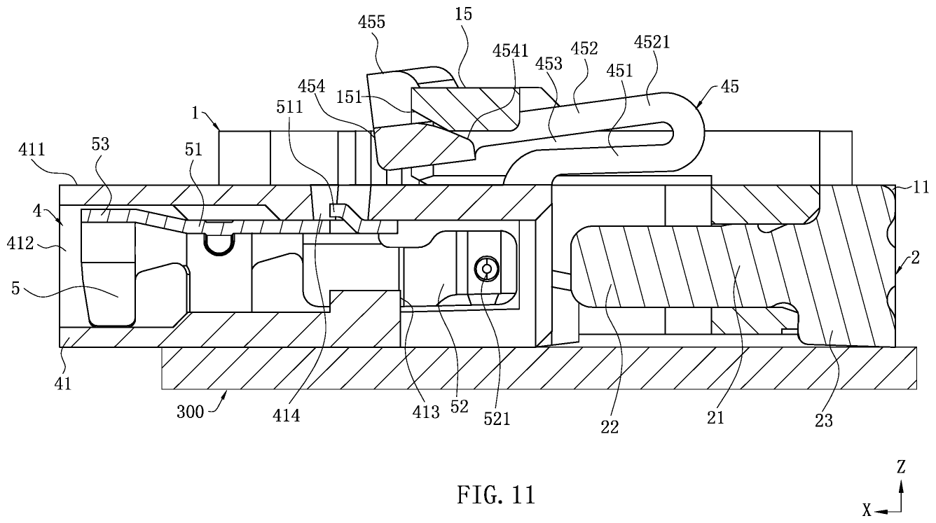

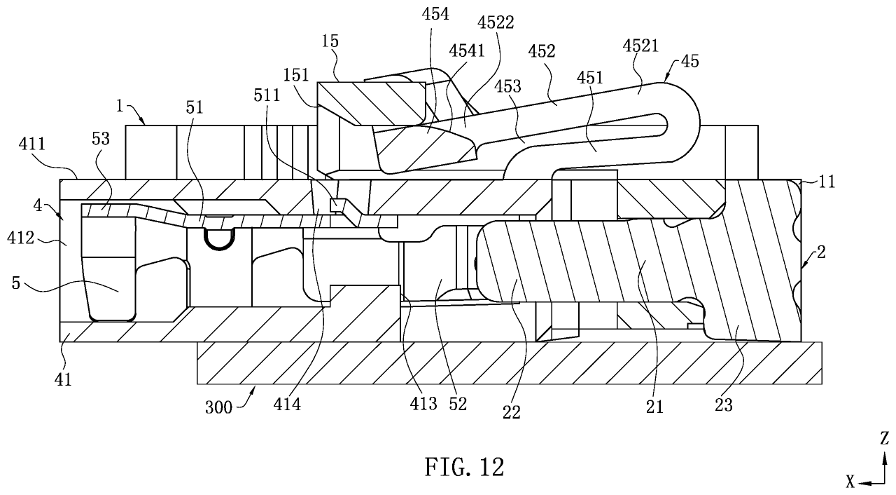

As shown in FIG. 10, FIG. 11 and FIG. 12, in the process of the plug connector 200 to be inserted backward into the socket connector 100, the second guiding chamfer 4541 is guided by the first guiding chamfer 151, and the locking portion 454 moves from the location below the corresponding clip portion 15 to be behind the corresponding clip portion 15, and the two are locked together, thus facilitating the locking of the plug connector 200 and the socket connector 100. When the locking portion 454 and the corresponding clip portion 15 detach from each other, the pressing portion 455 is pressed downward, such that the second elastic arm 452 moves downward, until the bottom surface of the second portion 4522 abuts the top surface 411 of the main body portion 41. The locking portion 454 moves from the location below the corresponding clip portion 15 to be in front of the corresponding clip portion 15, thus facilitating the detaching of the locking portion 454 and the corresponding clip portion 15.

As shown in FIG. 1 and FIG. 10, the mating terminals 5 are formed by punching a metal plate. The mating terminals 5 are one-to-one correspondingly accommodated in the accommodating holes 412. Each mating terminal 5 is provided with a base portion 51 accommodated in the corresponding accommodating hole 412, a mating portion 52 formed by extending backward from the base portion 51, and a cable connecting portion 53 formed by extending forward from the base portion 51. The base portion 51 is provided with a blocking portion 511 extending upward. The blocking portion 511 is formed by tearing from a plate surface of the base portion 51, and the blocking portion 511 protrudes into the corresponding through hole 414 to prevent the mating terminal 5 from retreating from the corresponding accommodating hole 412. The mating portion 52 is provided with two mating elastic sheets 521 extending backward, and the two mating elastic sheets 521 are used to clamp the contact portion 22 in the left-right direction, forming electrical connection between the two components. The cable connecting portion 53 is used to be connected to the cable (not shown).

In sum, the plug connector and the connector assembly having the same according to certain embodiments of the present invention have the following beneficial effects:

(1) The locking portions 454 are located at the front end of the locking arm 45. That is, the locking portions 454 are substantially located at the free tail end of the locking arm 45. The pressing portion 455 is provided to align with the locking portions 454 in the left-right direction. By pressing the pressing portion 455 downward, the locking portions 454 also move downward together in a greater distance, such that the locking arm 45, with a small deformation amount, may facilitate detachment of the locking portions 454 and the corresponding clip portions 15, thereby suppressing the locking arm 45 from fatigue and even breaking due to being excessively pressed, and ensuring the usage life of the locking arm 45. In addition, the locking portions 454 are laterally formed from the left side and the right side of the locking arm 45 respectively, such that the plug connector 200 may facilitate a thin design.

(2) The blocking portion 511 of each mating terminal 5 protrudes into the corresponding through hole 414, thus preventing the mating terminal 5 from retreating from the corresponding accommodating hole 412. The front end surface of the second elastic arm 452 is located behind the corresponding through hole 414, which is conducive for a sliding block forming the through hole 414 to be ejected from the mold.

(3) The top surface of the pressing portion 455 is higher than the top surface of each clip portion 15, allowing an operator to press the pressing portion 455 downward.

(4) Each clip portion 15 is provided with the first guiding chamfer 151 facing downward, and the first guiding chamfer 151 is provided obliquely backward and downward from the front end surface of the corresponding clip portion 15. Each locking portion 454 is provided with a second guiding chamfer 4541 facing upward, and the second guiding chamfer 4541 is provided obliquely forward and upward from the back end surface of the corresponding locking portion 454. The second guiding chamfer 4541 is guided by the first guiding chamfer 151, such that the corresponding locking portion 454 moves to be behind the corresponding clip portion 15.

(5) The locking arm 45 includes the first elastic arm 451 formed by extending upward and backward from the top surface 411 of the main body portion 41, and the second elastic arm 452 formed by extending forward from the first elastic arm 451. The second elastic arm 452 is located above the first elastic arm 451, and the separation slot 453 is formed between the first elastic arm 451 and the second elastic arm 452. The locking portions 454 are formed by laterally protruding from the front end of the second elastic arm 452 along the left-right direction, and each locking portion 454 is located in front of the corresponding first elastic arm 451. By the n-shaped structure of the locking arm 45, the overall length of the locking arm 45 for deformation is increased, such that the elasticity of the locking arm 45 becomes better, thus satisfying the usage requirement, increasing the usage life of the locking arm 45, increasing the insertion number of the socket connector 100 and the plug connector 200, and saving the machining cost. Further, each locking portion 454 is located in front of the first elastic arm 451, thus providing sufficient space for the locking portion 454 to deform.

(6) In the vertical direction, the first distance D1 between the second portion 4522 and the top surface 411 of the main body portion 41 is greater than the second distance D2 between the top surface of each locking portion 454 and the bottom surface of the corresponding clip portion 15, thus providing sufficient space for each locking portion 454 to move downward, and allowing each locking portion 454 and the corresponding clip portion 15 to detach from each other.

(7) The elastic arm 121 has the first arm 124 extending forward from the extending arm 120 and the second arm 125 bending reversely from the first arm 124 and extending backward. The second arm 125 is backward connected to the rear wall 11. The opening slot 122 is formed between the first arm 124 and the extending arm 120 and runs forward therethrough. The through slot 126 is formed between the second arm 125 and the first arm 124. The buckling portion 127 is formed at a side of the second arm 125 away from the first arm 124, and the buckling portion 127 is provided to correspond to the through slot 126 and the opening slot 122 in the left-right direction. By the n-shaped structure of the elastic arm 121, the overall length of the elastic arm 121 for deformation is increased, such that the elasticity of the elastic arm 121 becomes better, thus increasing the insertion number of the electrical connector 100 and the mating connector 200, satisfying the usage requirement, increasing the usage life of the elastic arm 121, and saving the machining cost.

(8) The opening slot 122 includes the first slot 122a and the second slot 122b connected to the back end of the first slot 122a. The first slot 122a runs forward through the corresponding side wall 12. A width W1 of the front end of the first slot 122a in the left-right direction is greater than a width W2 of the back end of the first slot 122a in the left-right direction, thus providing sufficient reserved space for the elastic arm 121 to deform in the left-right direction, and preventing the first arm 124 from colliding the extending arm 120 and resulting in damage to the insulating seat 1.

(9) Each extending arm 120 is fixed with one of the fixing members 3. Each fixing member 3 is provided with the retaining portion 31 and the mounting portion 32. The retaining portion 31 is fixed with interference to the corresponding side wall 12 at a location behind the opening slot 122, such that the corresponding fixing member 3 avoids the opening slot 122 and is fixed to the corresponding side wall 12, and the corresponding side wall 12 is not damaged due to the interference force provided by the fixing member 3. The mounting portion 32 is located in front of the buckling portion 127. The soldering portion 23 of each conductive terminal 2 is exposed to the rear wall 11 and is soldered downward to the circuit board 300. The mounting portion 32 is used to be mounted on the circuit board 300, such that the front end and the back end of the electrical connector 100 are simultaneously on the circuit board 300.

(10) The insulating seat 1 further includes the top wall 14 connected to the rear wall 11, and the top wall 14 is located above the mating space 13. The two grooves 142 are backward concavely provided on the left side and the right side of the front end of the top wall 14 respectively. Each groove 142 is provided to be adjacent to the corresponding second arm 125. The back end of each groove 142 is located behind the corresponding buckling portion 127, thus providing sufficient space for forming the buckling portion 127. Each clamping portion 42 is exposed to the corresponding groove 142, which is convenient for detecting whether the buckling portion 127 and the clamping portion 42 are buckled in position, thus preventing the two components from being not buckled.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A plug connector, configured to be inserted into a socket connector, the plug connector comprising:
an insulating body, comprising a main body portion and a locking arm formed by extending from a top surface of the main body portion, wherein two locking portions are formed by laterally protruding from a left side and a right side of a front end of the locking arm, each of the locking portions is configured to be locked with a clip portion of the socket connector, each of the locking portions is located in front of a connecting location of the locking arm and the main body portion, a pressing portion is formed between the two locking portions by protruding upward from the front end of the locking arm, and the pressing portion is provided to align with the locking portions in a left-right direction; and
at least one mating terminal, provided in the insulating body, wherein the at least one mating terminal is provided with at least one mating portion to mate with at least one conductive terminal of the socket connector.

2. The plug connector according to claim 1, wherein the locking arm comprises a first elastic arm formed by extending upward and backward from a top surface of the main body portion and a second elastic arm formed by extending forward from the first elastic arm, the second elastic arm is located above the first elastic arm, a separation slot is formed between the first elastic arm and the second elastic arm, the locking portions are formed by laterally protruding from a front end of the second elastic arm in the left-right direction, and the locking portions are located in front of the first arm.

3. The plug connector according to claim 2, wherein the second elastic arm comprises a first portion connected to the first elastic arm and a second portion extending forward from the first portion, a portion of the second elastic arm passing forward beyond the first elastic arm is defined as the second portion, and in a vertical direction, a distance between the second portion and the top surface of the main body portion is greater than a distance between the first portion and the first elastic arm.

4. The plug connector according to claim 3, wherein the pressing portion and the two locking portions are provided on the second portion.

5. The plug connector according to claim 2, wherein a back end of each of the locking portions is located in front of the first elastic arm.

6. The plug connector according to claim 2, wherein a connecting location of the first elastic arm and the second elastic arm passes backward beyond a back end surface of the main body portion.

7. The plug connector according to claim 1, wherein a top surface of each of the locking portions is not higher than a top surface of the locking arm.

8. The plug connector according to claim 1, wherein each of the locking portions is provided with an guiding chamfer facing upward, the guiding chamfer is provided obliquely forward and upward from a back end surface of each of the locking portions, and a back end of the guiding chamfer is located in front of a back end of the pressing portion.

9. The plug connector according to claim 1, wherein the main body portion is provided with at least accommodating hole accommodating the at least one mating terminal and at least one through hole running through the top surface of the main body portion, the at least one accommodating hole runs through the main body portion in a front-rear direction, each of the at least one through hole is in communication with a corresponding one of the at least one accommodating hole, each of the at least one mating terminal is provided with a blocking portion, the blocking portion protrudes into the through hole to prevent the mating terminal from retreating from the accommodating hole, and a front end surface of the second arm is located behind the through hole.

10. A connector assembly, comprising:
a socket connector, comprising an insulating seat and at least one conductive terminal provided in the insulating seat, wherein the insulating seat comprises a rear wall and a top wall formed by protruding forward from the rear wall, the rear wall and the top wall form a mating space, a recess is backward concavely provided on a front end of the top wall, the insulating seat is provided with two clip portions at a left side and a right side of the recess, and the conductive terminal has a contact portion exposed to the mating space; and
a plug connector, inserted backward into the mating space of the socket connector, wherein the plug connector comprises an insulating body and at least one mating terminal provided in the insulating body, the insulating body is provided with a main body portion and a locking arm formed by extending from a top surface of the main body portion, the locking arm is accommodated in the recess, two locking portions are formed by respectively protruding from a left side and a right side of a front end of the locking arm, the two locking portions are located in front of a connecting location of the locking arm and the main body portion, the two locking portions are respectively located behind the two clip portions correspondingly such that the locking portions and the clip portions are correspondingly locked to each other, a pressing portion is formed by protruding upward from the front end of the locking arm, the pressing portion is located between the two locking portions and aligned to the two locking portions in a left-right direction, and the mating terminal is provided with a mating portion to be conductively connected to the contact portion.

11. The connector assembly according to claim 10, wherein a top surface of the pressing portion is higher than a top surface of each of the clip portions.

12. The connector assembly according to claim 10, wherein a top surface of each of the locking portions is lower than a top surface of each of the clip portions.

13. The connector assembly according to claim 10, wherein the locking arm comprises a first elastic arm formed by extending upward and backward from a top surface of the main body portion and a second elastic arm formed by extending forward from the first elastic arm, the second elastic arm is located above the first elastic arm, a separation slot is formed between the first elastic arm and the second elastic arm, the locking portions are formed by protruding from a front end of the second elastic arm in the left-right direction, and the locking portions are located in front of the first arm.

14. The connector assembly according to claim 13, wherein in a vertical direction, a distance between a portion of the second elastic arm passing forward beyond the first elastic arm and the top surface of the main body portion is greater than a distance between a top surface of each of the locking portions and a bottom surface of a corresponding one of the clip portions.

15. The connector assembly according to claim 10, wherein the main body portion is provided with at least accommodating hole accommodating the at least one mating terminal and at least one through hole running through the top surface of the main body portion, the at least one accommodating hole runs through the main body portion in a front-rear direction, each of the at least one through hole is in communication with a corresponding one of the at least one accommodating hole, each of the at least one mating terminal is provided with a blocking portion, the blocking portion protrudes into the through hole to prevent the mating terminal from retreating from the accommodating hole, and a front end surface of the second arm is located behind the through hole.

16. The connector assembly according to claim 10, wherein two protruding portions are formed by respectively extending upward from the top wall at a left side and a right side of the recess, and each of the clip portions is formed by protruding from a corresponding one of the two protruding portions toward the recess in the left-right direction.

17. The connector assembly according to claim 10 wherein each of the clip portions is provided with a first guiding chamfer facing downward, the first guiding chamfer is provided obliquely backward and downward from a front end surface of each of the clip portions, each of the locking portions is provided with a second guiding chamfer facing upward, the second guiding chamfer is provided obliquely forward and upward from a back end surface of each of the locking portions, the second guiding chamfer is guided by the first guiding chamfer, such that each of the locking portions moves to be behind a corresponding one of the clip portions.

18. The connector assembly according to claim 10, wherein a bottom surface of each of the clip portions and a top surface of the top wall are located on a same horizontal plane in a vertical direction.

19. The connector assembly according to claim 10, wherein each of the two side walls comprises an extending arm and an elastic arm provided close to the mating space relative to the extending arm, the elastic arm has a first arm extending forward from the extending arm and a second arm bending reversely from the first arm and extending backward, the second arm is backward connected to the rear wall, an opening slot is formed between the first arm and the extending arm and runs forward therethrough, a through slot is formed between the second arm and the first arm, a buckling portion is formed at a side of the second arm away from the first arm, the buckling portion is provided to correspond to the through slot and the opening slot in a left-right direction, and two clamping portions are respectively provided at a left side and a right side of the main body portion to correspondingly buckle with the buckling portions and to lock the plug connector to and the socket connector.

20. The connector assembly according to claim 19, wherein the opening slot comprises a first slot and a second slot connected to a back end of the first slot, the first slot runs forward through a corresponding side wall of the two side walls, and a width of a front end of the first slot in a left-right direction is greater than a width of the back end of the first slot in the left-right direction.

21. The connector assembly according to claim 19, wherein the extending arm of each of the two side walls is fixed with a fixing member, the fixing member is provided with a retaining portion and a mounting portion, the retaining portion is fixed with interference to a corresponding side wall of the two side walls at a location behind the opening slot, and the mounting portion is configured to be mounted on a circuit board.

22. The connector assembly according to claim 19, wherein two grooves are backward concavely provided on a left side and a right side of a front end of the top wall respectively, each of the two grooves is provided to be adjacent to the second arm of a corresponding side wall of the two side walls, the clamping portions are located behind the buckling portion, and each of the clamping portions is exposed to a corresponding groove of the two grooves.
